(19) United States
(12) Patent Application Publication
(10) Pub. No.: US 2013/0240791 A1
(43) Pub. Date: Sep. 19, 2013

(54) COMPOSITION, METHOD OF APPLICATION AND USE OF A NATURAL ADDITIVE FROM SOAPBARK TREE EXTRACTS TO IMPROVE THE QUALITY OF MEAT PRODUCTS

(71) Applicants: Maria Angelica FELLENBERG PLAZA, Santiago (CL); John Gabriel ALARCON CAMACHO, Quilpue (CL); Javier Ignacio SAINZ LOBO, Quilpue (CL)

(72) Inventors: Maria Angelica FELLENBERG PLAZA, Santiago (CL); John Gabriel ALARCON CAMACHO, Quilpue (CL); Javier Ignacio SAINZ LOBO, Quilpue (CL)

(21) Appl. No.: 13/872,326

(22) Filed: Apr. 29, 2013

Related U.S. Application Data
(63) Continuation of application No. 11/790,098, filed on Apr. 23, 2007.

(30) Foreign Application Priority Data
Apr. 24, 2006 (CL) 948-2006

(51) Int. Cl. A23L 3/3481

(52) U.S. Cl. CPC A23L 3/3481
USPC 252/404

(57) ABSTRACT

A method for making an antioxidant composition that is useful for the preservation of foodstuffs. The antioxidant composition contains soapbark tree polyphenols, and is obtained as a permeate from an extract of Quillaja saponaria Molina. The extract contains quantities of saponin, polyphenol, and polysaccharide. The permeate removes saponins, to provide a composition having enriched quantities of polyphenols and polysaccharides, and a reduced quantity of saponin in comparison to the quantity of saponin in the extract.

### CROSS-REFERENCE TO RELATED APPLICATIONS

This application is a continuation application of U.S. Ser. No. 11/790,098, filed Apr. 23, 2007 (pending), which claims the priority of Chilean Patent Application CN 948-2006, filed Apr. 24,2006, the disclosures of which are incorporated herein by reference.

### FIELD OF THE INVENTION

The present application for invention patent relates to a composition, method and use of a natural product for preserving meat products in general. Specifically, it relates to the composition, method of application and use of a natural additive from soapbark tree extracts to improve the quality of meat products, principally useful because of its antioxidant action which helps the long term preservation of meat products in general.

### PREVIOUS ART

An important form of food deterioration in general, and more specifically, meat products, is the lipoperoxidation phenomenon or fat oxidation, also known as rancidness. These oxidative processes are triggered by certain chemical species (free radicals) that subtract a relatively labile electron from the fatty acid structure triggering the onset of the fat oxidation process. One way to stop or control this process is by applying antioxidants to meat products. The antioxidants are electron givers that stabilize free radicals and stop or reduce the lipoperoxidative process,

Depending on their origin, there are synthetic and natural antioxidants. The first ones, in spite of having a very good cost/benefit relationship, have the disadvantage of being questioned for having certain carcinogenic characteristics, thus their use is restricted and limited to small doses.

On the other hand, among natural antioxidants there are some vegetable extracts that have the ability to give up electrons. Among the latter, we have extracts of rosemary, sage, oregano, some carotenoids and polyphenols from different vegetable species. Even if their natural origin does not guarantee their innocuousness, there is some literature on having been largely ingested by the population via infusions or directly as a food additive.

Among meat products, a Broiler chicken is a poultry which has been genetically selected to produce meat in a short time (42 days). One problem related to this kind of meat is the fact that due to the necessary incorporation of unsaturated fatty acids into the poultry diet, these are deposited into the muscles, resulting in meat that Is more susceptible to suffering from lipid oxidation once stored. This affects not only the life span of the final product (meat), but it also produces a gradual, nutritional and organoleptic deterioration of poultry meat from the time of slaughtering until the meat is finally consumed. An appropriate cold chain and vacuum packaging are mechanisms that reduce the speed of these processes, but they do not stop them. Indeed, the addition of antioxidants to a substrate susceptible to suffering from oxidation is an effective way to considerably stop or reduce the lipoperoxidation process and to complement the previous palliative measures. There is a possibility of adding synthetic antioxidants to meat, such as Butyl hydroxyanisole (BHA), Butyl hydroxyl toluene (BUT), t-butyl hydroxyquinone (TBBQ) and propyl gallate (PG). However, these are limited by regulations on food additives and, what is more, have been questioned for their innocuousness.

As stated before, some investigation and development (I&D) have been conducted worldwide in order to find natural antioxidants which, when added to food and specially to meat, allow the slopping and reduction of the lipoperoxidatives processes, thus increasing its life span and providing consumers with high quality food. Even if a substance of vegetable origin may not be understood as a guarantee for innocuousness, there would still be some information on a previous consumption by a population without showing signs of health problems. Such is the case of honey, a substance with reducing sugars, that has been applied as natural antioxidant in turkey meat, thus decreasing the lipoperoxidation of the treated meat compared to controls (without additives). Additionally, turkey sausages treated with natural antioxidants (vitamin E, galic acid, and rosemary extracts), showed lower radiation induced lipoperoxidation compared to those sausages that were not protected by such antioxidants. In said study, vitamin E and galic acid showed an improved antioxidant effect compared to rosemary extract. The above contrasts with the antioxidant activity of rosemary, coffee, tea and grape seed extracts compared to the synthetic antioxidant BHA in dehydrated chicken meat. In this case, the authors found that rosemary extract had an equivalent behaviour comparable to BEA.

The use of natural antioxidants to improve the nutritive and oxidative quality of chicken meat is an emerging topic and there remains the need for inexpensive sources of polyphenols that can fulfill, the needs of this application at an industrial level and in a competitive way.

Among the uses of natural antioxidants we can mention, the USA 2004/0234671 application for invention patent which discloses a method and a system for processing muscat grape and extracting an antioxidant compound thereof to finally utilize it in certain formulations on several types of food. Additionally, antioxidants from grape extracts have been used for treating beverages and food, as is disclosed by the Japanese Patent JP 2005143377.

On the other hand, the topic on the use of soapbark tree tor generating antioxidants useful for preserving food has not been disclosed and it is an object of this invention. Nevertheless, the Japanese Patent JP 62243681 discloses the possibility of obtaining an antioxidant which comprises one or more extracts of Quillaja Saponaria Molina (soapbark tree). However, such disclosure encompasses general information and it does not define its use on food, and even less so on meat products.

Having seen the previous art, there is a need to formulate a natural antioxidant preferably from an innocuous product and that allows the effective control of the lipoperoxidation phenomenon in meat products. In this sense, the solution approached by the invention proposes a composition that can be formulated as powder or liquid from soapbark tree polyphenols and as will be demonstrated below, it shows a high antioxidant activity.

Specifically, it is an objective of this invention, to minimize the phenomenon of oxidative rancidness of meat fat that affects the nutritive and organoleptic quality thereof The composition is formulated from a soapbark tree extract, which can, preferably but not exclusively, be obtained from an extract rich In saponins and polyphenols. Once saponins are extracted from a permeate of soapbark tree, the remaining is a polyphenol rich fraction that is purified afterwards in order to produce the extract used in the composition of the invention. Nevertheless, it is also possible to produce a polyphenol rich extract directly from a permeate from a soapbark tree. Thus, an affordable product can be obtained. The main advantage of this invention is the incorporation of antioxidant extracts from soapbark tree polyphenols applied to meat products which results in a benefit not only for the improved life span of meat but it would also reduce waste material from the soap bark tree industry according to international regulations on clean production matters.

### DETAILED DESCRIPTION OF THE INVENTION

The composition of the invention is formulated from a soapbark tree extract, clearly of natural origin, hydrosoluble that has an antioxidant capacity with different kinds of meat. Preferably, but not exclusively, the composition of the invention is obtained from a soapbark tree extract, rich in saponins, polyphenols and polysaccharides. As a point of interest, the soapbark tree extract which is rich in polyphenols and polysaccharides used in the composition formulation may correspond to a product from a permeate with its saponins extracted, then, the saponin free fraction, rich in polyphenols, is purified to obtain the aforementioned extract. Thus, the composition may eventually have a small quantity of saponins that, as a whole, sinergically give the composition a high antioxidant capacity.

A preferred way to carry out the invention is to have the composition in a liquid formulation, rich in polyphenols from a soapbark tree permeated. Such composition is formulated as follows:
Concentrations of solids: 35-45%
Water: 55-65%
Total Phenols Between 1.4-5.4%
Polysaccharides: Between 3.5-15.8%

The antioxidant capacity of this liquid composition will be given by the percentage of inhibition of DPPH (Diphenylpicrylhydrazyl) using 0.2 phenol of soap bark tree/1 mol of DPPH: between 50-90%. In this way, in the tests carried out, 6 to 28 g. of the product may achieve a 75% of inhibition of 1 mmol of DPPH. In another preferred way of carrying out the invention, the composition is formulated as a powder, also rich in polyphenols, and which has the following characteristics:
Total phenols: Between 4-12%
Polysaccharides: Between 10-35%
Antioxidant Capacity: % Inhibition of DPPH using 0.2 mols of soapbark tree phenol/1 mol of DPPH; Between 50-90%. In this way, in tests carried-out with 3-10 g of the products a 75% inhibition of 1 mmol of DPPH cars be achieved.

In case of the product being powder, the humidity level is less than 8% w/w.

As can be seen, the quantity of polyphenols in both the liquid composition and the powder are variable depending on the antioxidant capacity desired and the specific formulation of the product.

As an example, an extract of soapbark tree polyphenols was applied to a marinated chicken leg and breast. The extract was dissolved without problems and different concentrations could be tested, including concentrations around the upper level. The application was carried out with brine with doses which ranged between 0.05 and 0.15% of dissolution. The tests carried out on base line lipoperoxidation and susceptibility to lipoperoxidation show that the dose with the most oxidative protection was the dose of 0.15% of the extract into the marinade. Additionally, a sense test was carried out on the chicken meat treated with soapbark tree extracts.

Base line lipoperoxidation, corresponds to the oxidation process quantification of meat fat in conditions where no treatment has been conducted apart from the addition of protective extracts. The induced lipoperoxidation corresponds to the measurement of the oxidation in pro-oxidant conditions. Two treatments were considered in the aforementioned example; (l) the exposure of the samples at 37.degree, C, for 20 minutes and (2) the exposure of the samples at 37,degree. C. for 20 minutes after adding 10 Mm of iron to the marinade (an. oxidation accelerating additive).

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

An application of an extract of soapbark tree polyphenols applied to. a chicken leg which demonstrates the aforementioned results is shown on Table 1, We can then conclude that the control only manifests significantly greater after 6 days of refrigeration for the base-line lipoperoxidation.

The lipoperoxidation induced by temperature, and by temperature plus iron is significantly greater in the control than in the meat treated with different concentrations of the extract of soapbark tree polyphenols.

TABLE 1
Results of the application of the extract of
soapbark tree polyphenols to chicken legs.

| | DO/g of tissue | | | | | |
|---|---|---|---|---|---|---|
| | Concentration (%) | | | | | |
| Ref. days | 0 | 0.05 | 0.1 | 0.15 | 0.2 | Ave. |

A. - Base line lipoperoxidation

| | | | | | |
|---|---|---|---|---|---|
| 0 | 0.056 ^{A} | 0.021 ^{A} | 0.039 ^{A} | 0.037 ^{A} | 0.053 ^{A} |
| 2 | 0.147 ^{A} | 0.068 ^{A} | 0.053 ^{A} | 0.077 ^{A} | 0.112 ^{A} |
| 4 | 0.092 ^{A} | 0.135 ^{A} | 0.087 ^{A} | 0.089 ^{A} | 0.083 ^{A} |
| 6 | 0.187 ^{A} | 0.082 ^{B} | 0.319 ^{A} | 0.166 ^{AB} | 0.258 ^{A} |
| 8 | 0.220 ^{A} | 0.208 ^{A} | 0.336 ^{A} | 0.136 ^{A} | 0.280 ^{A} |
| Ave. | | | | | |

B. - Lipoperoxidation Induced by Temperature (incubation at 37° C.)

| | | | | | |
|---|---|---|---|---|---|
| 0 | 0.149 ^{A} | 0.029 ^{A} | 0.047 ^{A} | 0.077 ^{A} | 0.072 ^{A} |
| 2 | 0.426 ^{A} | 0.171 ^{AB} | 0.095 ^{B} | 0.226 ^{A} | 0.355 ^{A} |
| 4 | 0.450 ^{A} | 0.168 ^{AB} | 0.209 ^{AB} | 0.102 ^{B} | 0.091 ^{B} |
| 6 | 0.849 ^{A} | 0.105 ^{BC} | 0.485 ^{B} | 0.245 ^{BC} | 0.311 ^{BC} |
| 8 | 0.316 ^{A} | 0.316 ^{A} | 0.222 ^{A} | 0.195 ^{A} | 0.385 ^{A} |
| Ave. | | | | | |

C. - Lipoperoxidation Induced by Temperature and Iron (incubation at 37° C.)

| | | | | | | |
|---|---|---|---|---|---|---|
| 0 | 0.594 | 0.043 | 0.186 | 0.263 | 0.223 | 0.261 ^{b} |
| 2 | 1.031 | 0.534 | 0.213 | 0.537 | 0.816 | 0.626 ^{a} |
| 4 | 0.388 | 0.210 | 0.094 | 0.160 | 0.210 | 0.212 ^{b} |
| 6 | 1.073 | 0.162 | 0.523 | 0.276 | 0.613 | 0.529 ^{a} |
| 8 | 0.779 | 0.382 | 0.613 | 0.329 | 0.654 | 0.551 ^{a} |
| Ave. | 0.773 ^{A} | 0.266 ^{B} | 0.326 ^{B} | 0.313 ^{B} | 0.503 ^{B} | |

Note:
Ref. Days: The cuts of marinated chicken legs with different brines with 0 concentration (control), 0.05%, 0.1%, 0.15% and 0.2% of the extract of barksoap tree polyphenols are refrigerated for 0, 2, 4, 6 and 8 days at 6° C. refrigerating temperature, and frozen at −80° C. immediately afterwards to subject them to basal and induced lipoperoxidation analysis. The protocol analysis is in accordance with the literature.
DO/g of tissue: the absorbance measurement indicates the optic density at 532 nanometers per gram of oxygen of a homogenized tissue solution (chicken leg). A greater value shows greater oxidation (and therefore less protection of the meat).

The results of the application of the extract of soapbark tree polyphenols on chicken breasts are shown on table 2. In this case, the control is significantly greater than all concentrations and for all the refrigeration times for the base-line lipoperoxidation, that is to say the extract protected the meat in all the cases.

No Important differences for the different concentrations in the temperature induced lipoperoxidation were shown.

The lipoperoxidation induced by temperature plus iron, although always greater, shows important statistics on days 0 and 2 of refrigeration. In this analysis, the greater concentration of soapbark tree polyphenols (0.2%) showed a pre-oxidant effect after 2 days of refrigeration.

TABLE 2
Results of the application of the extract of
soapbark tree polyphenols on chicken breasts.

| | DO/g of tissue | | | | | |
|---|---|---|---|---|---|---|
| | Concentration (%) | | | | | |
| Ref. days | 0 | 0.05 | 0.1 | 0.15 | 0.2 | Ave. |

A.- Base line lipoperoxidation

| | | | | | | |
|---|---|---|---|---|---|---|
| 0 | 0.085 | 0.018 | 0.035 | 0.020 | 0.042 | 0.040 ^{b} |
| 2 | 0.110 | 0.029 | 0.040 | 0.038 | 0.076 | 0.058 ^{ab} |
| 4 | 0.113 | 0.062 | 0.040 | 0.053 | 0.064 | 0.066 ^{ab} |
| 6 | 0.144 | 0.070 | 0.047 | 0.060 | 0.102 | 0.084 ^{a} |
| 8 | 0.106 | 0.096 | 0.120 | 0.055 | 0.083 | 0.091 ^{a} |
| Ave. | 0.112 ^{A} | 0.055 ^{B} | 0.056 ^{B} | 0.045 ^{B} | 0.074 ^{B} | |

B.- Lipoperoxidation Induced by Temperature (incubation at 37° C.)

| | | | | | | |
|---|---|---|---|---|---|---|
| 0 | 0.077 | 0.040 | 0.060 | 0.034 | 0.051 | 0.052 ^{c} |
| 2 | 0.119 | 0.107 | 0.093 | 0.060 | 0.178 | 0.111 ^{a} |
| 4 | 0.117 | 0.087 | 0.065 | 0.097 | 0.103 | 0.093 ^{ab} |
| 6 | 0.083 | 0.064 | 0.065 | 0.075 | 0.052 | 0.067 ^{ba} |
| 8 | 0.158 | 0.141 | 0.094 | 0.107 | 0.096 | 0.119 ^{a} |
| Ave. | 0.111 ^{A} | 0.088 ^{A} | 0.075 ^{A} | 0.075 ^{A} | 0.096 ^{A} | |

C.- Lipoperoxidation Induced by Temperature and Iron (incubation at 37° C.)

| | | | | | |
|---|---|---|---|---|---|
| 0 | 2.427 ^{A} | 0.205 ^{B} | 0.320 ^{A} | 0.323 ^{B} | 0.348 ^{B} |
| 2 | 1.669 ^{A} | 1.395 ^{AB} | 0.410 ^{B} | 0.460 ^{B} | 2.179 ^{A} |
| 4 | 0.967 ^{A} | 0.127 ^{A} | 0.203 ^{A} | 0.415 ^{A} | 0.578 ^{A} |
| 6 | 0.129 ^{A} | 0.101 ^{A} | 0.133 ^{A} | 0.103 ^{A} | 1.024 ^{A} |
| 8 | 0.354 ^{A} | 0.189 ^{A} | 0.071 ^{A} | 0.165 ^{A} | 0.140 ^{A} |
| Ave. | | | | | |

Note:
Ref. Days: The cuts of marinated chicken legs with different brines with 0 concentration (control), 0.05%, 0.1%, 0.15% and 0.2% of the extract of barksoap tree polyphenols, are refrigerated for 0, 2, 4, 6 and 8 days at 6° C. refrigerating temperature, and frozen at −80° C. immediately afterwards, to subject them to basal and induced lipoperoxidation analysis. The protocol analysis is in accordance with the literature.
DO/g of tissue: the absorbance measurement indicates the optic density at 532 nanometers per gram of oxygen of a homogenized tissue solution (chicken breast). Greater value shows greater oxidation (and therefore less protection of the meat).

It is concluded that, with respect to the analysis of the sense test carried out, in both eases, legs or breasts, the samples are well preserved until, the 6th day of refrigeration and the best samples corresponded to the 0.05% and 0.10% doses.

The entire disclosure[s] of all applications, patents and publications, cited herein and of corresponding Chilean Application No. 948-2006, filed Apr. 24, 2006 is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof can make various changes and modifications of the invention to adapt it to various usages and conditions.

1-16. (canceled)

17. A method for making a soapbark tree permeate rich in polyphenols, useful as an antioxidant composition, comprising the steps of:
extracting saponins, polyphenols and polysaccharides from soapbark tree to form a soapbark tree extract:
forming a soapbark tree permeate by removing saponins from the soapbark tree extract, the soapbark free permeate being rich in polyphenols.

18. The method according to claim 17 further including the step of purifying the soapbark tree permeate.

19. The method according to claim 17 wherein the soapbark tree permeate has an enriched quantity of polyphenols, in comparison to the quantity of polyphenol in the soapbark tree extract and a reduced quantity of saponin in comparison to the quantity of saponin in the soapbark tree extract.

20. The method according to claim 19, wherein the soapbark tree permeate comprises phenols at 1.4-5.4% by weight, polysaccharides at 3.5-15.8% by weight, and a reduced quantity of saponin, relative to the soapbark tree extract.

21. The method according to claim 20, wherein the soapbark tree permeate is in a liquid form comprising a concentration of solids of 35 to 45% and liquid in the amount of 55 to 65%.

22. A method for making an antioxidant composition comprising soapbark tree polyphenols, the antioxidant composition, obtained, as a permeate from an extract of Quillaja saponaria Molina, wherein the extract of Quillaja saponaria Molina comprises quantities of saponin, polyphenol, and polysaccharide, wherein the permeate comprises an enriched quantity of polyphenols and polysaccharides in comparison to the quantity of polyphenol in the extract, and a reduced quantity of saponin in comparison to the quantity of saponin in the extract.
